(19) United States
(12) Patent Application Publication
(10) Pub. No.: US 2023/0217554 A1
(43) Pub. Date: Jul. 6, 2023

(54) INDUCTION HEATING DEVICE AND METHOD OF CONTROLLING INDUCTION HEATING DEVICE

(71) Applicant: LG Electronics Inc., Seoul (KR)

(72) Inventors: Sihoon JEONG, Seoul (KR); John Kang, Seoul (KR); Hoseop Ahn, Seoul (KR); Kyelyong Kang, Seoul (KR)

(21) Appl. No.: 18/092,618

(22) Filed: Jan. 3, 2023

(30) Foreign Application Priority Data
Jan. 5, 2022 (KR) 10-2022-0001832
Apr. 19, 2022 (KR) 10-2022-0048529

(51) Int. Cl. H05B 6/06; H05B 6/12

(52) U.S. Cl. CPC H05B 6/062; H05B 6/1209

(57) ABSTRACT

An induction heating device according to an embodiment includes a rectifying circuit configured to rectify an AC voltage supplied from a power supply, a smoothing circuit configured to smooth a voltage output from the rectifying circuit, an inverter comprising a plurality of switches and configured to supply current to a working coil, a shunt resistor coupled between the smoothing circuit and the inverter, a drive circuit configured to supply switching signals to the plurality of switches provided in the inverter, respectively, and a controller configured to determine a driving frequency of the inverter and drive the working coil by supplying a control signal based on the driving frequency to the driving circuit.

### CROSS-REFERENCE TO RELATED APPLICATION

This application claims priority to and the benefit of Korean Patent Application No. 10-2022-0001832, filed on Jan. 5, 2022, and Korean Patent Application No. 10-2022-0048529, filed on Apr. 19, 2022, the disclosure of which are incorporated herein by reference in their entirety.

### BACKGROUND

### Technical Field

The present disclosure relates to an induction heating device and a method for controlling an induction heating device.

### Background of the Disclosure

An induction heating device generates eddy currents in a metallic container by using a magnetic field that is created around a working coil, to heat the container. As an induction heating device operates, alternating current (AC) currents are supplied to the working coil. As the AC currents are supplied to the working coil, an induced magnetic field is created around the working coil. As the magnetic line of force of the induced magnetic field, created around the working coil, passes through the bottom surface of the metallic container placed on the working coil, eddy currents are generated in the container. As the eddy currents flow in the container, the container is heated by Joule heat that is generated by the resistance of the container.

FIG. 1 is a circuit diagram of an induction heating device.

The induction heating device 7 shown in FIG. 1 may include two working coils 712 and 714, that is, a first working coil 712 and a second working coil 714. The first working coil 712 and the second working coil 714 may be disposed at positions corresponding to a first heating region and a second heating region, respectively.

In addition, the induction heating device 7 may include a rectifying circuit 702, a smoothing circuit 704, a first inverter (or inverter) 706 and a second inverter (or inverter) 708.

The rectifying circuit 702 may include a plurality of diodes and configured to rectify the voltage supplied from a power supply 700. The smoothing circuit 704 may include an inductor L and a direct current (DC) link capacitor CD and configured to output a DC voltage by smoothing the voltage output from the rectifying circuit 702.

The first inverter 706 is a half bridge circuit including two switches (SW1 and SW2) and two capacitors (C1 and C2). The second inverter 708 is a half bridge circuit including two switches SW3 and SW4 and two capacitors (C3 and C4).

When receiving switching signals (S1 to S4), the first inverter 706 and the second inverter 708 may convert the currents input through the rectifying circuit 702 and the smoothing circuit 704 into alternating currents and may supply the alternating currents to the first working coil 712 and the second working coil 714, respectively.

The induction heating device 7 shown in FIG. 1 may include a first current transformer (CT) sensor CT1 configured to sense currents that are input to the first working coil 712 and the second working coil 714, that is, input currents. Specifically, the induction heating device 7 may include one CT sensor configured to sense the input currents of the plurality of inverters.

The induction heating device 7 shown in FIG. 1 may include a second CT sensor CT2 and a third CT sensor CT3 that are configured to sense currents flowing through the first working coil 712 and the second working coil 714, respectively, that is, resonance currents, when the first working coil 712 and the second working coil 714 are driven.

According to FIG. 1, a controller provided in the induction heating device 7 may be configured to determine whether eccentricity occurs between a container and the first working coil 712 or the second working coil 714 when the container disposed on the first working coil 712 or the second working coil 714 is heated.

The eccentricity between the working coil and the container means a state in which the center of the working coil and the center of the container do not coincide with each other. If the eccentricity between the working coil and the container occurs, the power supplied to the container by the working coil could be deteriorated. Accordingly, in order to match the size of the power supplied by the working coil with a required power value, the size of the current supplied to the working coil may increase. If the size of the current supplied to the working coil increases, a circuit connected to the working coil may be overloaded or an element included in the circuit connected to the working coil may be burnt out or the induction heating device may malfunction.

In addition, the induction heating device may include two or more working coils and the two or more working coils may be driven at the same time. If eccentricity occurs between the container and one of the two or more working coils, the size of the current supplied to the corresponding working coil could increase and output power values of the other working coils could be reduced.

Accordingly, the controller of the induction heating device 7 may prevent circuit overload or burnout, or malfunction thereof by determining whether eccentricity occurs between the working coil and the container.

For the controller to determine the presence of eccentricity occurring between the working coil and the container, the size of the current input to each of the working coils, that is, the size of input current should be measured.

FIG. 2 is a graph showing a driving timing of the first working coil 712 and a driving timing of the second working coil 714.

FIG. 2 includes a graph 722 showing a change in an output power value of the first working coil 712 and a graph 724 showing a change in an output power value of the second working coil 714.

As shown in FIG. 1, the induction heating device 7 includes only one CT sensor for sensing the input currents of the first working coil 712 and the second working coil 714, that is, a first CT sensor CT1. When the first working coil 712 and the second working coil 714 are driven, the input currents of the first working coil 712 and the second working coil 714 are alternately sensed in order to precisely sense the input current of each working coil.

To precisely sense the size of the current input to each working coil, each working coil is turned off in predetermined sections. For example, as shown in FIG. 2, there are sections T1, T2, T3 and T4 in which output power values of the first working coil 712 and the second working coil 714 become 0 (zero).

The controller determines the size of the current input to the second working coil 714 by using the first CT sensor CT1 in each section T1 and T2 in which the output power value of the first working coil 712 becomes 0 (zero). In addition, the controller determines the size of the current input to the first working coil 712 by using the first CT sensor CT1 in each section T3 and T4 in which the output power value of the second working coil 714 becomes 0 (zero). In other words, when one of the working coils is not put into operation, that is, when one of the working coils is turned off, the controller may measure the size of the current input to the other working coil and precisely obtain the input current value of each working coil.

After all, since the input current values of the plural inverters must be sensed by one CT sensor, a very complicated current measurement method shown in FIG. 2 is required to obtain the accurate input current value disadvantageously.

In addition, the driving of the other working coil must be stopped to sense the input current value of one working coil when two working coils are driven at the same time. Due to this structure, the working coils are frequently turned on and off, and there may be a problem of noise occurrence.

### SUMMARY

An aspect of the present disclosure is to provide an induction heating device that may determine occurrence of eccentricity between a working coil and a container by easily measuring an input current value of each working coil based on simple control, and a method of controlling the induction heating device.

Another aspect of the present disclosure is to provide an induction heating device that may generate no noise caused by stopping the driving of the other working coil when an input current value of one of two or more working coils is measured to determine occurrence of eccentricity between a working coil and a container, and a method of controlling the induction heating device.

Aspects according to the present disclosure are not limited to the above ones, and other aspects and advantages that are not mentioned above may be clearly understood from the following description and may be more clearly understood from the embodiments set forth herein.

An induction heating device according to an embodiment may include a rectifying circuit configured to rectify an AC voltage supplied from a power supply; a smoothing circuit configured to smooth a voltage output from the rectifying circuit; an inverter comprising a plurality of switches and configured to supply current to a working coil; a shunt resistor coupled between the smoothing circuit and the inverter; a drive circuit configured to supply switching signals to the plurality of switches provided in the inverter, respectively; and a controller configured to determine a driving frequency of the inverter and drive the working coil by supplying a control signal based on the driving frequency to the driving circuit.

In an embodiment, the controller may calculate an output power value of the working coil based on current value measured through the shunt resistor. In an embodiment, the controller may calculate a final output power value of the working coil based on the output power value of the working coil.

In an embodiment, the controller may determine whether eccentricity occurs between the working coil and a container based on the final output power value.

The controller may calculate the final output power value based on an output power value of the working coil measured in an on-period of the working coil.

The controller may determine a moving average of an average value of integrated values of the output power values of the working coil calculated for every preset driving time period as the final output power value.

When a required power value of the working coil exceeds a preset first reference value, the working coil may be driven in a linear driving scheme.

When a required value of the working coil is equal to or less than the preset first reference value, the working coil may be driven in an on-off driving scheme.

The controller may periodically determine whether eccentricity occurs between the working coil and the container at preset time intervals.

The controller may determine that no eccentricity occurs between the working coil and the container when the final output power value exceeds a preset second reference value.

The controller may determine that eccentricity occurs between the working coil and the container when the final output power value is equal to or less than the preset second reference value.

The controller may control an output power value of the working coil to be changed into a preset limit value when determining that eccentricity occurs between the working coil and the container.

In an embodiment, a method of controlling an induction heating device may include measuring a current value that is the size of current flowing through a shunt resistor coupled between a smoothing circuit and an inverter; calculating an output power value of a working coil based on the current value; calculating a final output power value of the working coil based the output power value of the working coil; and determining whether eccentricity occurs between the working coil and a container based on the final output power value.

The final output power value may be calculated based on an output power value of the working coil measured in an on-period of the working coil.

A moving average value of an average value of integrated values of the output power value of the working coil calculated for every preset driving time period may be determined as the final output power value.

When a required power value of the working coil exceeds a preset first reference value, the working coil may be driven in a linear driving scheme.

When a required value of the working coil is equal to or less than the first reference value, the working coil may be driven in an on-off driving scheme.

It may be periodically determined whether eccentricity occurs between the working coil and the container at preset time intervals.

It may be determined that no eccentricity occurs between the working coil and the container when the final output power value exceeds a preset second reference value.

It may be determined that eccentricity occurs between the working coil and the container when the final output power value is equal to or less than the preset second reference value.

An output power value of the working coil may be changed into a preset limit value when determining that eccentricity occurs between the working coil and the container.

According to the embodiments, through simple control, the input current value of each working coil may be easily measured. Accordingly, it may be determined based on the simple control whether eccentricity occurs between the working coil and the container.

According to the embodiments described above, when determining the power value of one of the two or more working coils in order to determine whether eccentricity occurs between the working coil and the container, the driving of the other working coil(s) may not be stopped. Accordingly, noise due to frequent on and off of the working coil may not occur.

### BRIEF DESCRIPTION OF DRAWINGS

FIG. 1 is a circuit diagram of an induction heating device;

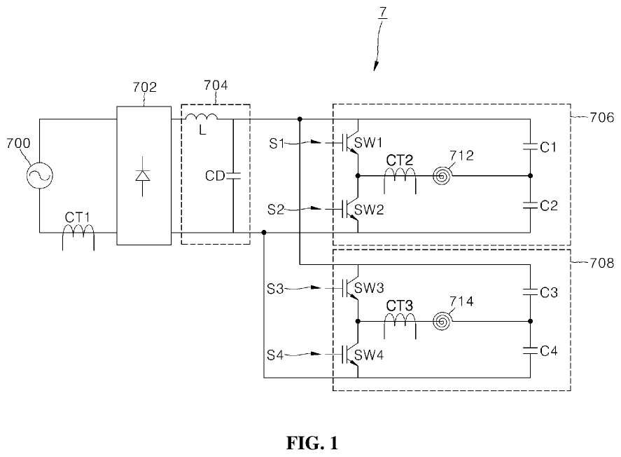

FIG. 2 is a graph showing a driving timing of a first working coil and a driving timing of a second working coil in the induction heating device according to FIG. 1;

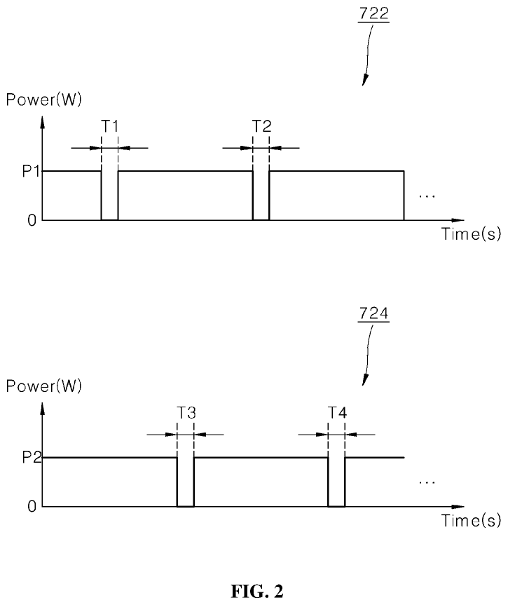

FIG. 3 is an exploded perspective view of an induction heating device according to an embodiment;

FIG. 4 is a circuit diagram of an induction heating device according to an embodiment;

FIG. 5 is a graph showing a change in an output current value of a working coil when a working coil is driven in a linear driving method;

FIG. 6 is a graph showing a change in an output current value of a working coil when a working coil is driven in an ON-OFF driving method; and

FIG. 7 is a flow chart showing a method of controlling the induction heating device according to an embodiment.

### DETAILED DESCRIPTION

The above-described aspects, features and advantages may be described hereunder with reference to the accompanying drawings such that one having ordinary skill in the art to which the present disclosure pertains may easily implement the technical spirit of the disclosure. In the disclosure, detailed description of known technologies in relation to the disclosure may be omitted if they are deemed to make the gist of the disclosure unnecessarily vague. Below, preferred embodiments according to the disclosure are specifically described with reference to the accompanying drawings and should not be construed as limiting the scope of the disclosure. In the drawings, identical reference numerals may denote identical or similar components.

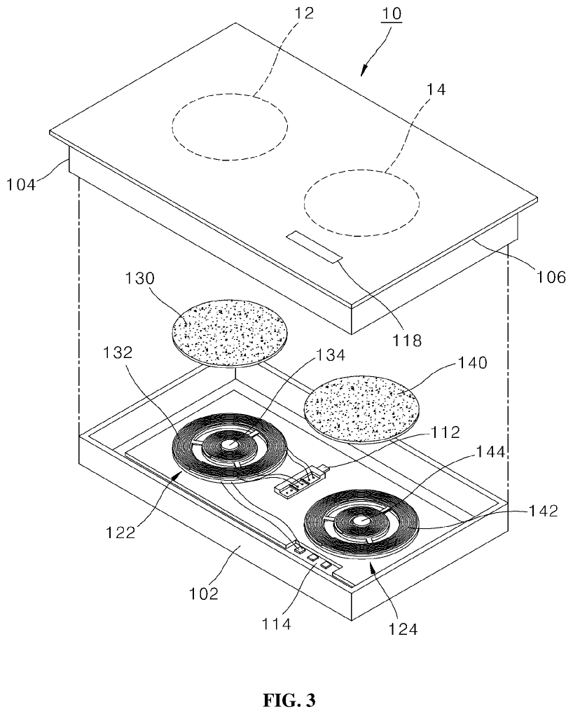

FIG. 3 is an exploded perspective view of an induction heating device according to an embodiment.

The induction heating device 10 according to an embodiment of the present disclosure may include a case 102 defining a body thereof and a cover plate 104 coupled to the case 102 to seal the case 102.

The cover plate 104 may be coupled to an upper surface of the case to close the space formed inside the case 102 from the outside environment. The cover plate 104 may include a top plate 106 on which a container for cooking food is placed. The top plate 106 may be made of a tempered glass material such as ceramic glass, but is not limited thereto. The material of the top plate 106 may vary according to embodiments.

Heating regions 12 and 14 corresponding to working coil assemblies 122 and 124, respectively, may be formed at the top plate 106. Lines or figures corresponding to the heating regions 12 and 14 may be printed or displayed on the top plate 106 in order for a user to clearly recognize the positions of the heating regions 12 and 14.

The case 102 may have a hexahedral shape with an open top. The working coil assemblies 122 and 124 for heating a container or vessel may be disposed in the space formed inside the case 102. In addition, an interface 114 may be provided inside the case 102 and have functions to adjust a power level of each heating region 12 and 14 and display related information of the induction heating device 10. The interface 114 may be a touch panel that is capable of both inputting information and displaying information by touch, but the interface 114 having a different structure may be provided according to embodiments.

A manipulation region 118 may be formed in a position corresponding to the interface 114 at the top plate 106. For user manipulation, characters or images may be printed on the manipulation region 118. The user may perform a desired operation by touching a specific point of the manipulation region 118 with reference to the characters or images pre-printed on the manipulation region 118.

The user may set the power level of each heating region 12 and 14 through the interface 114. The power level may be indicated by a number (e.g., 1, 2, 3, . . . , 9) on the manipulation region 118. When the power level for each heating region 12 and 14 is set, the required power value and the heating frequency of the working coil assemblies responding to the respective heating regions 12 and 14 may be determined. A controller may drive each working coil so that the actual output power value may match the required power value set by the user based on the determined heating frequency.

In the space formed inside the case 102, there may be further provided a power source part 112 for supplying power to the working coil assemblies 122 and 124 or the interface 114.

In the embodiment of FIG. 3, two working coil assemblies (i.e., a first working coil assembly 122 and a second working coil assembly 124) are disposed inside the case 102. However, three or more working coil assemblies may be provided in the case 102 according to other embodiments.

Each working coil assembly 122 and 124 may include a working coil configured to induce a magnetic field using a high frequency alternating current supplied by the power source part 112, and an insulating sheet configured to protect the coil from heat generated by the container. For example, the first working coil assembly 122 shown in FIG. 3 may include a first working coil 132 for heating the container put on the first heating region 12 and a first insulating sheet 130. The second working coil assembly 124 may include a second working coil 142 and a second insulating sheet 140. The insulating sheet may not be provided according to embodiments.

In addition, a temperature sensor may be provided at the center of each working coil. For example, a temperature sensor 134 may be provided in the center of the first working coil 132 as shown in FIG. 3. Another temperature sensor 144 may be provided in the center of the second working coil 142. The temperature sensor may measure the temperature of the container put on each heating region. In one embodiment of the present disclosure, the temperature sensor may be a thermistor temperature sensor having a variable resistance of which a resistance value changes according to the temperature of the container, but is not limited thereto.

In the embodiment, the temperature sensor may output a sensing voltage corresponding to the temperature of the container and the sensing voltage output from the temperature sensor may be transmitted to the controller. The controller may check the temperature of the container based on the magnitude of the sensing voltage output from the temperature sensor. When the temperature of the container is a preset reference value or more, the controller may perform an overheat preventing operation of lowering an output power value of the working coil or stopping the driving of the working coil.

Although not shown in the drawings, a circuit board on which a plurality of circuits or elements including a controller may be disposed in the space formed inside the case 102. For example, the controller may be a microprocessor or a logic circuit.

The controller may perform a heating operation by driving each working coil based on the user's heating start command input through the interface 114. When the user inputs a heating terminating command through the interface 114, the controller may stop the driving of the working coil to terminate the heating operation.

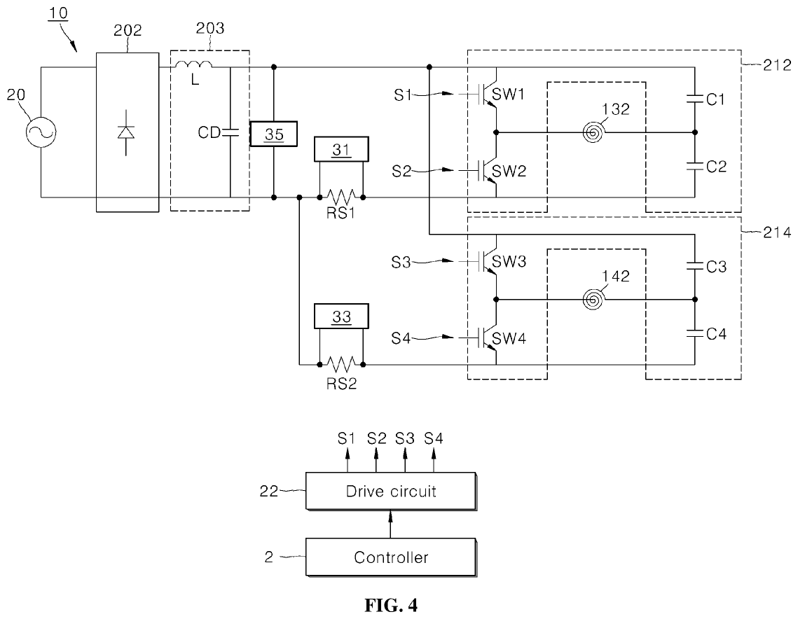

FIG. 4 is a circuit diagram of an induction heating device according to an embodiment.

The induction heating device 10 according to one embodiment may include a rectifying circuit 202, a smoothing circuit 203, a first inverter (or a first inverter circuit) 212, a working coil 132, a second inverter (or a second inverter circuit) 214, a second working coil 142, a controller 2 and a drive circuit 22.

The rectifying circuit 202 may include a plurality of diodes. According to the embodiment, the rectifying circuit 202 may be a bridge diode circuit, but it may be another type of circuit according to other embodiments. The rectifying circuit 202 may be configured rectify the AC input voltage supplied from a power source 20, thereby outputting a voltage having a pulsating waveform.

The smoothing circuit 203 may smooth the voltage rectified by the rectifying circuit 202 and output a DC link voltage. The smoothing circuit 203 may include an inductor L and a DC link capacitor CD.

The first inverter 212 may include a first switch SW1, a second switch SW2, a first capacitor C1 and a second capacitor C2. The first switch SW1 may be connected in series to the second switch SW2. The first capacitor Cl may be connected in series to the second capacitor C2. The first working coil 132 may be connected between the connection point of the first switch SW1 and the second switch SW2, and the connection point of the first capacitor C1 and the second capacitor C2. The first inverter 212 may convert the current output from the smoothing circuit 204 into AC current, and may supply the converted AC current to the first working coil 132.

The second inverter 214 may include a third switch SW3, a fourth switch SW4, a third capacitor C3 and a fourth capacitor C4. The third switch SW3 may be connected in series to the fourth switch SW4. The third capacitor C3 may be connected in series to the fourth capacitor C4. The second working coil 142 may be connected between the connection point of the third switch SW3 and the fourth switch SW4, and the connection point of the third capacitor C3 and the fourth capacitor C4. The second inverter 214 may convert the current output from the smoothing circuit 204 into AC current, and may supply the converted AC current to the second working coil 142.

The DC link voltages input to the inverters 212 and 214 may be converted into AC currents by the turn-on and turn-off operations of the switches SW1, SW2, SW3 and SW4 provided in the inverters 212 and 214. The AC currents converted by the inverters 212 and 214 may be supplied to the working coils 132 and 142, respectively. When the AC currents are supplied to the working coils 132 and 142, a resonance phenomenon may occur in the working coils 132 and 142, and eddy current may flow through the container to heat the container.

In an embodiment, the first switch SW1 and the second switch SW2 may be alternately turned on and off. In the embodiment, the third switch SW3 and the fourth switch SW4 may be alternately turned on and off.

The controller 2 may be configured to output a control signal for controlling the drive circuit 22. The drive circuit 22 may supply switching signals S1, S2, S3 and S4 to the switches SW1, SW2, SW3 and SW4 provided in the inverters 212 and 214, respectively, based on the control signal supplied by the controller 2. The first switching signal S1, the second switching signal S2, the third switching signal S3 and the fourth switching signal S4 may be Pulse Width Modulation (PWM) signal having a predetermined duty cycle.

When receiving the AC current output from the inverter 212 and 214, the working coils 132 and 142 may be driven. When the working coils 132 and 142 are driven, eddy currents may flow through the container put on the working coils 132 and 142 to heat the container. The size (or magnitude) of the thermal energy supplied to the container may vary based on the size of the power substantially generated by the working coils when the working coils are driven, that is, actual output power values of the working coils.

When the user changes an operation state of the induction heating device 10 into a Power On state through the manipulation region 118, power may be supplied to the induction heating device 10 from an external power supply 20 and the induction heating device 10 may enter a driving standby state. Hence, the user may put a container on the first heating region 12 and/or the second heating region 14 provided at the induction heating device 10 and set a power level for the first heating region 12 and/or the second heating region 14 to input a heating-start command Once the user inputs the heating-start command, the controller 2 may determine a required power value of each working coil 132 and 142 corresponding to the power level set by the user.

Upon receiving the heating-start command, the controller 2 may determine a frequency corresponding to the required power value of each working coil 132 and 142, that is, a heating frequency, and may supply a control signal corresponding to the determined heating frequency to the drive circuit 22. Accordingly, switching signals S1, S2, S3 and S4 may be output from the drive circuit 22, and may be input to the switches SW1, SW2, SW3 and SW4, respectively, to drive the working coils 132 and 142. When the working coils 132 and 142 are driven, Eddy current may flow through the container to heat the container.

In an embodiment, the controller 2 may determine a heating frequency corresponding to the power level set by the user. For example, when the user sets a power level for the heating region, the controller 2 may gradually lower a driving frequency of each inverter 212 and 214 until the output power value of each working coil 132 and 142 matches a required power value corresponding to the power level set by the user, in a state in which the driving frequency of each inverter 212 and 214 is set as a preset reference frequency. The controller 2 may determine a frequency, at which the output power value of each working coil 132 and 142 matches the required power value, as the heating frequency.

The controller 22 may supply a control signal corresponding to the determined heating frequency to the drive circuit 22. Based on the control signal output by the controller 2, the drive circuit 22 may output switching signals S1, S2, S3 and S4 having a duty ratio corresponding to the heating frequency determined by the controller 2. While the switches SW1, SW2, SW3 and SW4 are alternately turned on and off based on the input switching signals S1, S2, S3 and S4, AC current may be supplied to the working coils 132 and 142 and the container put on the heating region may be then heated.

In an embodiment, the induction heating device 10 may include shunt resistances RS1 and RS2. A first shunt resistance RS1 may be connected between the smoothing circuit 203 and the first inverter 212, and a second shunt resistance RS2 may be connected between the smoothing circuit 203 and the second inverter 214.

In an embodiment, the induction heating device 10 may include input current sensors 31 and 33 configured to sense the size of current flowing through the shunt resistances RS1 and RS2, that is, current values. A first input current sensor 31 may be configured to sense the current flowing through the first shunt resistance RS1 and the second input current sensor 33 may be configured to sense the current flowing through the second shunt resistance RS2.

The controller 2 may determine (or calculate) the size of the current input to each working coil 132 and 142, that is, a current value.

In an embodiment, the controller 2 may sense the size of the voltage applied to both ends of the DC link capacitor CD by using a voltage sensor 35, that is, a DC link voltage value.

In an embodiment, the controller 2 may determine an output power value of each working coil 132 and 142 based on [Equation 1].

P=V_{dc}I_{avg} [Equation 1]

In [Equation 1], P refers to an output power value of each working coil 132 and 142. Vdc refers to the size of the voltage applied to both ends of the DC link capacity CD, that is, a DC link voltage value. Iavg refers to an average value of the current value sensed at each shunt resistor RS1 and RS2.

The controller 2 may determine the final output power value of each working coil 132 and 142 based on the output power value of each working coil 132 and 142. In an embodiment, the controller 2 may determine a moving average value of an average value of integrated values of the output power values of the working coils 132 and 142 calculated for each predetermined driving time, as the final output power value.

In an embodiment, the working coils 132 and 142 may be driven in a linear driving scheme or an on-off driving scheme. According to the linear driving scheme, the working coils 132 and 142 may be maintained in an on state without being turned off, so that the output power values of the working coils 132 and 142 may be maintained constant. According to the on-off driving scheme, the working coils 132 and 142 may be maintained in an on state and an off state for a predetermined period.

In an embodiment, when the required power value of each working coil 132 and 142 exceeds a preset first reference value, each working coil 132 and 142 may be driven based on the linear driving scheme. When the required power value of each working coil 132 and 142 is equal to or less than the preset first reference value, each working coil 132 and 142 may be driven based on the on-off driving scheme.

For example, when the required power value of the first working coil 132 corresponding to the heating level set by the user exceeds the preset first reference value (e.g., 600 W), the first working coil 132 may be driven based on the linear driving scheme.

If the required power value of the first working coil 132 corresponding to the heating level set by the user is equal to or less than the preset first reference value (e.g., 600 W), the first working coil 132 may be driven based on the on-off driving scheme. When the first working coil 132 is driven in the on-off driving scheme, an average value of the output power values of the first working coil 132 may be controlled to be equal to the required power value in a period in which the first working coil 132 is maintained in an on-state, that is, an on-period.

In an embodiment, the controller 2 may determine (or calculate) the final output power value based on the output power value measured in the on-period of each working coil 132 and 142. When the working coils 132 and 142 are driven in the linear driving scheme, the working coils 132 and 142 may be constantly maintained in the on-state. Accordingly, the controller 2 may constantly determine the final output power value of each working coil 132 and 142. When the working coils 132 and 142 are driven in the on-off driving scheme, the controller 2 may determine (or calculate) the final output power value of each working coil 132 and 142 based on the output power value measured in the period in which each working coil 132 and 142 is maintained in the on-state.

The controller 2 may determine whether eccentricity occurs between each working coil 132 and 142 with the container based on the final output power value. In an embodiment, the controller may determine that no eccentricity occurs between the working coils 132 and 142 and the container when the final output power value of each working coil 132 and 142 exceeds a preset second reference value. The controller 2 may determine that eccentricity occurs between the working coils 132 and 142 and the container when the final output value of each working coil is equal to or more than the preset second reference value.

In an embodiment, the controller may periodically determine whether eccentricity occurs between the working coils 132 and 142 and the container at preset time intervals.

When determining that eccentricity occurs between the working coils 132 and 142 and the container, the controller 2 may control the output power value of each working coil 132 and 142 to be changed into a preset limit value. For example, when determining that eccentricity occurs between the first working coil 132 and the container, the controller 2 may adjust the output power value of the first working coil 132 to be a preset limit value (e.g., 100 W or 0 W). Accordingly, overload or burnout of the circuit connected to the first working coil 132 and malfunction of the induction heating device may be prevented.

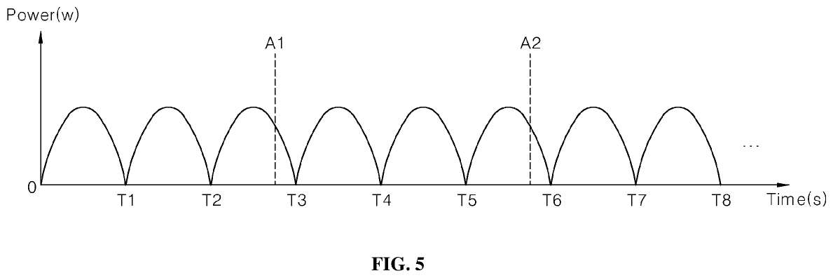

FIG. 5 is a graph showing a change in an output current value of a working coil when a working coil is driven in a linear driving method.

For example, when the required power value of the first working coil 132 exceeds a preset first reference value (e.g., 600 W), the first working coil 132 may be driven in the linear driving scheme. FIG. 5 shows change in the output power value of the first working coil 132 over time when the required power value of the first working coil 132 exceeds the preset first reference value.

In an embodiment, the controller 1 may periodically determine whether eccentricity occurs between the first working coil 132 and the container at predetermined intervals. For example, the controller 2 may determine whether eccentricity occurs between the first working coil 132 and the container at every preset determination time point (e.g., A1, A2, . . . ).

The controller may calculate a final output power value based on the output power value measured in the on-period of the first working coil 132. According to the linear driving scheme, the first working coil 132 may be maintained to keep the on-state for all of the driving time periods (e.g., 0˜T1, T1˜T2, T2˜T3, T3˜T4, . . . ), and the controller 2 may determine (or calculate) the final output power value by measuring the output power value for every driving time period (e.g., 0˜T1, T1˜T2, T2˜T3, T3˜T4, . . . ).

At every determination time point (A1, A2, . . . ), the controller 2 may compare the final output power value of the first working coil 132 to a preset second reference value (e.g., 450 W), and may determine occurrence of eccentricity between the first working coil 132 and the container based on the result of the comparison. The controller 2 may determine whether eccentricity occurs between the first working coil 132 and the container based on a moving average value of average values of the output power values of the first working coil 132 measured at every driving time (e.g., 0˜T1, T1˜T2, T2˜T3, T3˜T4, . . . ).

As one example, at a determination time point A1, the controller 2 may determine an average value of integrated values of the output power values for the driving time periods 0 to T1 and integrated values of the output power values for the driving time periods T1 to T2 as the final output power value. Then, the controller 2 may compare the calculated final output power value to the preset second reference value (e.g., 450 W) and determine whether eccentricity occurs between the first working coil 132 and the container based on the result of the comparison.

As another example, at a determination time point A2, the controller 2 may determine an average value of integrated values of the output power values for the driving time periods T3 to T4 and integrated values of the output power values for the driving time periods T4 to T5 as the final output power value. Then, the controller 2 may compare the calculated final output power value to the preset second reference value (e.g., 450 W) and determine whether eccentricity occurs between the first working coil 132 and the container based on the result of the comparison.

As a further example, at a determination time point A2, the controller 2 may determine (or calculate) an average value of integrated values of the output power values of the driving time periods T2 to T3, an average value of integrated values of the output power values of the driving time periods T3 to T4, and an average value of integrated values of the output power values of the driving time periods T3 to T4 as the final output power values. Then, the controller 2 may compare the calculated final output power values to the preset second reference value (e.g., 450 W) and determine whether eccentricity occurs between the first working coil 132 and the container based on the result of the comparison.

In short, the controller 2 may calculate, as the final output power values, a moving average value of the average values of the integrated values of a predetermined number of (e.g., 2 or 4) output power values measured in the on-period of the working coil prior to the current determination time point.

The controller 2 may determine that no eccentricity occurs between the first working coil 132 and the container when the final output power value of the first working coil 132 exceeds the preset second reference value. The controller 2 may determine that eccentricity occurs between the first working coil 132 and the container when the final output power value of the first working coil 132 is equal to or less than the preset second reference value.

Upon determining that eccentricity occurs between the first working coil 132 and the container, the controller may control the output power value of the first working coil 132 to be changed into a preset limit value. For example, when determining that eccentricity occurs between the first working coil 132 and the container, the controller 2 may adjust the output power value of the first working coil 132 to be a preset limit value (e.g., 100 W or 0 W).

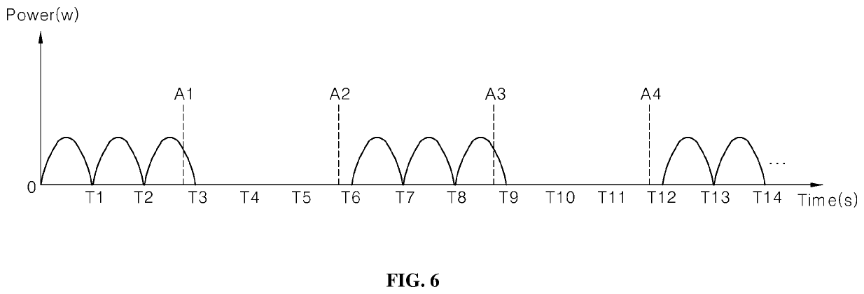

FIG. 6 is a graph showing a change in an output current value of a working coil when a working coil is driven in an ON-OFF driving method.

For example, when the required power value of the first working coil 132 is equal to or less than the preset first reference value (e.g., 600 W), the first working coil 132 may be driven in the on-off driving scheme. FIG. 6 shows a change in the output power value of the first working coil 132 over time, when the required power value of the first working coil 132 is equal to or less than the preset first reference value.

In an embodiment, the controller the controller 1 may periodically determine whether eccentricity occurs between the first working coil 132 and the container at predetermined intervals. For example, the controller 2 may determine whether eccentricity occurs between the first working coil 132 and the container at every preset determination time point (e.g., A1, A2, A3, A4 . . . ).

The controller 2 may calculate a final output power value based on the output power value measured in the on-period of the first working coil 132. According to the on-off driving scheme, the driving time periods of the first working coil 132 may be divided into on-periods (0˜T3, T6˜T9, T12˜T15, . . . ) and off-periods (T3˜T6, T9˜T12, . . . ). The controller 2 may determine the final output power value based on the output power values measured in the on-periods (0˜T3, T6˜T9, T12˜T15, . . . ) of the first working coil 132.

At every determination time point (A1, A2, A3, A4, . . . ), the controller 2 may compare the final output power value of the first working coil 132 to a preset second reference value (e.g., 450 W), and may determine occurrence of eccentricity between the first working coil 132 and the container based on the result of the comparison. The controller 2 may determine whether eccentricity occurs between the first working coil 132 and the container based on a moving average value of average values of the output power values of the first working coil 132 measured in the on-periods (0˜T3, T6˜T9, T12˜T15, . . . ).

As one example, at a determination time point A1, the controller 2 may determine an average value of integrated values of the output power values for the driving time periods 0 to T1 and integrated values of the output power values for the driving time periods T1 to T2 as the final output power value. Then, the controller 2 may compare the calculated final output power value to the preset second reference value (e.g., 450 W) and determine whether eccentricity occurs between the first working coil 132 and the container based on the result of the comparison.

As another example, at a determination time point A2, the controller 2 may determine an average value of integrated values of the output power values for the driving time periods T1 to T2 and integrated values of the output power values for the driving time periods T2 to T3 as the final output power value. Then, the controller 2 may compare the calculated final output power value to the preset second reference value (e.g., 450 W) and determine whether eccentricity occurs between the first working coil 132 and the container based on the result of the comparison.

As a further example, at a determination time point A2, the controller 2 may determine (or calculate) an average value of integrated values of the output power values of the driving time periods 0 to T1, an average value of integrated values of the output power values of the driving time periods T1 to T2, and an average value of integrated values of the output power values of the driving time periods T2 to T3 as the final output power values. Then, the controller 2 may compare the calculated final output power values to the preset second reference value (e.g., 450 W) and determine whether eccentricity occurs between the first working coil 132 and the container based on the result of the comparison.

As a still further example, at a determination time point A3, the controller 2 may determine (or calculate) an average value of integrated values of the output power values of the driving time periods T6 to T7 and an average value of integrated values of the output power values of the driving time periods T7 to T8 as the final output power values. Then, the controller 2 may compare the calculated final output power values to the preset second reference value (e.g., 450 W) and determine whether eccentricity occurs between the first working coil 132 and the container based on the result of the comparison.

As a still further example, at a determination time point A3, the controller 2 may determine (or calculate) an average value of integrated values of the output power values of the driving time periods T2 to T3, an average value of integrated values of the output power values of the driving time periods T6 to T7, and an average value of integrated values of the output power values of the driving time periods T7 to T8 as the final output power values. Then, the controller 2 may compare the calculated final output power values to the preset second reference value (e.g., 450 W) and determine whether eccentricity occurs between the first working coil 132 and the container based on the result of the comparison.

In short, the controller 2 may calculate, as the final output power values, a moving average value of the average values of the integrated values of a predetermined number of (e.g., 2 or 4) output power values measured in the on-period of the working coil prior to the current determination time point.

The controller 2 may determine that no eccentricity occurs between the first working coil 132 and the container when the final output power value of the first working coil 132 exceeds the preset second reference value. The controller 2 may determine that eccentricity occurs between the first working coil 132 and the container when the final output power value of the first working coil 132 is equal to or less than the preset second reference value.

Upon determining that eccentricity occurs between the first working coil 132 and the container, the controller may control the output power value of the first working coil 132 to be changed into a preset limit value. For example, when determining that eccentricity occurs between the first working coil 132 and the container, the controller 2 may adjust the output power value of the first working coil 132 to be a preset limit value (e.g., 100 W or 0 W).

According to the control method shown in FIGS. 3 to 6, the controller 2 may individually determine the final output power value of each working coil 132 and 142 regardless of the driving scheme of each working coil 132 and 142, when the first working coil 132 and the second working coil 142 are driven at the same time. After that, the controller 2 may individually determine whether eccentricity occurs between each working coil 132 and 142 and the container based on the final output power value of each working coil.

In the above, the embodiments based on the induction heating device 10 including two working coils 132 and 142 have been described with reference to FIGS. 3 to 6. However, embodiments of the present disclosure may be equally applied to an induction heating device including one working coil or an induction heating device including three or more working coils.

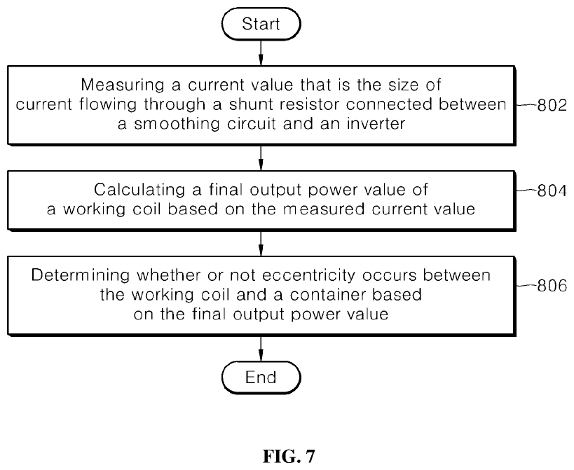

FIG. 7 is a flow chart showing a method of controlling the induction heating device according to an embodiment.

When at least one of the two working coils 132 and 142 is driven based on a heating-start command input by the user, the controller may measure a current value that is the size of current flowing through the shunt resistors RS1 and RS2 connected between the smoothing circuit 203 and the inverters 212 and 214 (802).

In an embodiment, when the required power values of the working coils 132 and 142 exceed the preset first reference value, the working coils 132 and 142 may be driven in the linear driving scheme.

In an embodiment, when the required power values are equal to or less than the preset first reference value, the working coils 132 and 142 may be driven in the on-off driving scheme.

The controller 2 may calculate the final output power values of the working coils 132 and 142 based on the current values measured through the shunt resistors RS1 and RS2 (804). The controller 2 may calculate the output power values of the working coils 132 and 142 based on the current value that is the size of the current flowing through the shunt resistors RS1 and RS2, and may calculate the final output power values of the working coils 132 and 142 based on the output power values of the working coils 132 and 142. In an embodiment, the controller 2 may calculate the final output power value based on the output power value measured in the on-period.

In an embodiment, the controller 2 may determine, as the final output power value, a moving average of an average of integrated values of the output power values of each working coil 132 and 142 measured for every predetermined driving period.

The controller 2 may determine whether eccentricity occurs between each working coil 132 and 142 and the container based on the calculated final output power value (806).

In an embodiment, the controller may periodically determine whether eccentricity occurs between each working coil 132 and 142 and the container at preset time intervals.

In an embodiment, the controller 2 may determine that no eccentricity occurs between each working coil 132 and 142 and the container when the final output power value of each working coil 132 and 142 exceeds the preset second reference value.

In an embodiment, the controller 2 may determine that eccentricity occurs between each working coil 132 and 142 and the container when the final output power value of each working coil 132 and 142 is equal to or less than the preset second reference value.

In an embodiment, upon determining that eccentricity occurs between each working coil 132 and 142 and the container, the controller 2 may control the output power value of each working coil 132 and 142 to be changed into a preset limit value.

According to the embodiments described above, when determining whether eccentricity occurs in the induction heating device including the plurality of working coils, a simpler control method may be applied in comparison to the prior art. Accordingly, control complexity of the induction heating device may be reduced.

According to the embodiments described above, when determining the power value of one of the two or more working coils in order to determine whether eccentricity occurs between the working coil and the container, the driving of the other working coil(s) need not be stopped. Accordingly, noise due to frequent on and off of the working coil may not occur.

The embodiments are described above with reference to a number of illustrative embodiments thereof. However, the present disclosure is not intended to be limited to the embodiments and drawings set forth herein, and numerous other modifications and embodiments can be devised by one skilled in the art. Further, the effects and predictable effects based on the configurations in the disclosure are to be included within the range of the disclosure though not explicitly described in the description of the embodiments.

What is claimed is:

1. An induction heating device comprising:
a rectifying circuit to rectify an alternating current (AC) voltage supplied from a power supply;
a smoothing circuit to smooth a voltage output from the rectifier circuit;
an inverter comprising a plurality of switches to convert the smoothed voltage output of the smoothing circuit into alternating current and supply the alternating current to a working coil;
a shunt resistor coupled between the smoothing circuit and the inverter;
a drive circuit to supply switching signals to the plurality of switches provided in the inverter, respectively; and
a controller configured to determine a driving frequency of the inverter and drive the working coil by supplying a control signal based on the driving frequency to the driving circuit,
wherein the controller is configured to calculate an output power value of the working coil based on current value measured through the shunt resistor, calculate a final output power value of the working coil based on the output power value of the working coil, and determine whether eccentricity occurs between the working coil and a container based on the final output power value.

2. The induction heating device of claim 1, wherein the controller is configured to calculate the final output power value based on an output power value of the working coil measured in an on-period of the working coil.

3. The induction heating device of claim 1, wherein the controller is configured to calculate a moving average of an average value of integrated values of output power values of the working coil which is calculated for every preset driving time period as the final output power value.

4. The induction heating device of claim 1, wherein when a required power value of the working coil exceeds a preset first reference value, the controller is configured to drive the working coil in a linear driving scheme, and
when the required value of the working coil is equal to or less than the preset first reference value, the controller is configured to drive the working coil in an on-off driving scheme.

5. The induction heating device of claim 1, wherein the controller is configured to periodically determine whether eccentricity occurs between the working coil and the container at preset time intervals.

6. The induction heating device of claim 1, wherein the controller is configured to determine that no eccentricity occurs between the working coil and the container when the final output power value exceeds a preset second reference value, and
the controller is configured to determine that eccentricity occurs between the working coil and the container when the final output power value is equal to or less than the preset second reference value.

7. The induction heating device of claim 1, wherein the controller is configured to control an output power value of the working coil to be changed into a preset limit value when the controller determines that eccentricity occurs between the working coil and the container.

8. A method of controlling an induction heating device comprising:
measuring a current value that is a size of current flowing through a shunt resistor coupled between a smoothing circuit and an inverter;
calculating an output power value of a working coil based on the current value;
calculating a final output power value of the working coil based on the output power value of the working coil; and
determining whether eccentricity occurs between the working coil and a container based on the final output power value.

9. The method of controlling the induction heating device of claim 8, wherein the final output power value is calculated based on the output power value of the working coil measured in an on-period of the working coil.

10. The method of controlling the induction heating device of claim 8, wherein a moving average value of an average value of integrated values of the output power value of the working coil calculated for every preset driving time period is determined as the final output power value.

11. The method of controlling the induction heating device of claim 8, wherein when a required power value of the working coil exceeds a preset first reference value, the working coil is driven in a linear driving scheme, and
when the required power value of the working coil is equal to or less than the preset first reference value, the working coil is driven in an on-off driving scheme.

12. The method of controlling the induction heating device of claim 8, wherein whether eccentricity occurs between the working coil and the container is periodically determined at preset time intervals.

13. The method of controlling the induction heating device of claim 8, wherein no eccentricity occurs between the working coil and the container is determined when the final output power value exceeds a preset second reference value, and
eccentricity occurs between the working coil and the container is determined when the final output power value is equal to or less than the preset second reference value.

14. The method of controlling the induction heating device of claim 8, wherein an output power value of the working coil is changed into a preset limit value when eccentricity occurs between the working coil and the container is determined.
